(19) United States
(12) Patent Application Publication
(10) Pub. No.: US 2021/0220939 A1
(43) Pub. Date: Jul. 22, 2021

(54) MIG TORCH HEAD SHIELD

(71) Applicants: Earl Starks, Wellington, CO (US); Andrew Torrez, Livermore, CO (US)

(72) Inventors: Earl Starks, Wellington, CO (US); Andrew Torrez, Livermore, CO (US)

(21) Appl. No.: 16/747,502

(22) Filed: Jan. 20, 2020

(51) Int. Cl. B23K 9/32; B23K 5/22

(52) U.S. Cl. CPC B23K 9/321; B23K 5/22

(57) ABSTRACT

A MIG torch head shield for protection of the eyes from arc flash during the welding process. The MIG torch head shield is further useful for allowing increased safety and ability to lighten a percentage of shade setting inside of helmets. The MIG torch head shield is also useful for providing a shaded or tinted vision of the arc welding when a helmet is not worn by a welder.

### FIELD OF THE INVENTION

This invention relates to welding. More particularly, it relates to a shield to protect from arc flash while welding.

### BACKGROUND

Welding is a fabrication or sculptural process that joins materials, usually metals or thermoplastics, by using high heat to melt the parts together and allowing them to cool causing fusion. Welding is distinct from lower temperature metal-joining techniques such as brazing and soldering, which do not melt the base metal.

In addition to melting the base metal, a filler material is typically added to the joint to form a pool of molten material (the weld pool) that cook to form a joint that, based on weld configuration (butt, full penetration, fillet, etc.), can be stronger than the base material (parent metal). Pressure may also be used in conjunction with heat, or by itself, to produce a weld. Welding also requires a form of shield to protect the filler metals or melted metals from being contaminated or oxidized.

Many different energy sources can be used for welding, including a gas flame (chemical), an electric arc (electrical), a laser, an electron beam, friction, and ultrasound. While often an industrial process, welding may be performed in many different environments, including in open air, under water, and in outer space. Welding is a hazardous undertaking and precautions are required to avoid burns, electric shock, vision damage, inhalation of poisonous gases and fumes, and exposure to intense ultraviolet radiation.

Until the end of the 19th century, the only welding process was forged welding, which blacksmiths had used for millennia to join iron and steel by heating and hammering. Arc welding and oxy-fuel welding were among the first processes to develop late in the century, and electric resistance welding followed soon after. Welding technology advanced quickly during the early 20th century as the world wars drove the demand for reliable and inexpensive joining methods.

Following the wars, several modern welding techniques were developed, including manual methods like shielded metal arc welding, now one of the most popular welding methods, as well as semi-automatic and automatic processes such as gas metal arc welding, submerged arc welding, flux-cored arc welding and electroslag welding. Developments continued with the invention of laser beam welding, electron beam welding, magnetic pulse welding, and friction stir welding in the latter half of the century. Today, the science continues to advance. Robot welding is commonplace in industrial settings, and researchers continue to develop new welding methods and gain greater understanding of weld quality.

Welding can be dangerous and unhealthy if the proper precautions are not taken. However, using new technology and proper protection greatly reduces risks of injury and death associated with welding. Since many common welding procedures involve an open electric arc or flame, the risk of burns and fire is significant; this is why it is classified as a hot work process. To prevent injury, welders wear personal protective equipment in the form of heavy leather gloves and protective long-sleeve jackets to avoid exposure to extreme heat and flames. Synthetic clothing such as non-fireproofed polyester should not be worn since it will ignite and burn rapidly. Additionally, the brightness of the weld area leads to a condition called arc eye or flash burns in which ultraviolet light causes inflammation of the cornea and can burn the retinas of the eyes. Goggles and welding helmets with dark UV-filtering face plates are worn to prevent this exposure. Since the 2000s, some helmets have included a face plate which instantly darkens upon exposure to the intense UV light. To protect bystanders, the welding area is often surrounded with translucent welding curtains. These curtains, made of a polyvinyl chloride plastic film, shield people outside the welding area from the UV light of the electric arc, but cannot replace the filter glass used in helmets.

A welding helmet is a type of headgear used when performing certain types of welding to protect the eyes, face and neck from flash burn, ultraviolet light, sparks, infrared light, and heat.

Welding helmets are most commonly used with arc welding processes such as shielded metal arc welding, gas tungsten arc welding, and gas metal arc welding. They are necessary to prevent arc eye, a painful condition where the cornea is inflamed. Welding helmets can also prevent retina burns, which can lead to a loss of vision. Both conditions are caused by unprotected exposure to the highly concentrated ultraviolet and infrared rays emitted by the welding arc. Ultraviolet emissions from the welding arc can also damage uncovered skin, causing a sunburn-like condition in a relatively short period of welding. In addition to the radiation, gasses or splashes can also be a hazard to the skin and the eyes.

Most welding helmets include a window covered with a filter called a lens shade, through which the welder can see to work. In most helmets, the window may be made of tinted glass, tinted plastic, or a variable-density filter made from a pair of polarized lenses.

It is becoming more and more common for welders to not use a welding helmet eye protection at all when welding with MIG welding due to the very controlled arc size and the built-in shielding of a nozzle that supplies inert gas to shield the arc from oxidizing the metal joint. Although freedom and visibility are improved by not wearing a helmet, in simple access situations, it is less so in difficult or upside-down welding. The welder may be suspect to arc flash reaching their eyes, skin, face, etc. There are inherent safety problems that exists for those that elect to go helmetless.

In light of the foregoing, there is a need for a device that can protect from arc flash while MIG welding when a welder elects not to use eye protection or helmets.

### BRIEF DESCRIPTION OF THE DRAWINGS

FIG. 1 is an illustrated view of an exemplary MIG torch head shield.

FIG. 2 is an illustrated view of a MIG torch with the MIG torch head shield shown in FIG. 1.

FIG. 3 is an illustrated view of arc rays or flash of the MIG torch shown in FIG. 2 with the MIG torch head shield shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

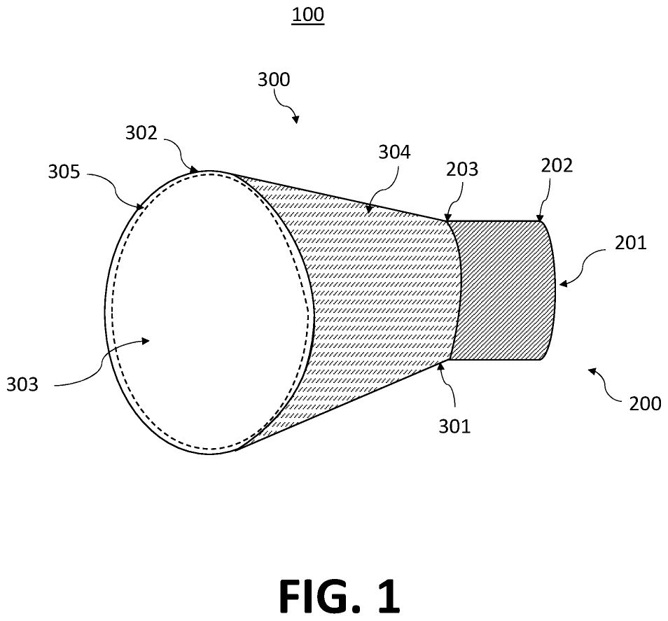

Referring to FIG. 1, an illustrated view of an exemplary MIG torch head shield 100 for additional safety while performing MIG welding is presented. The head shield 100 protects the welder's eyes from arc flash (infrared and ultraviolet radiation) by attenuation of the arc intensity at a distance normal to welding procedures. The MIG torch head shield 100 is useful for increasing a safety zone of arc flash for eye protection. The MIG torch head shield 100 is further useful for allowing increased safety and ability to lighten a percentage of shade setting inside of auto-dimming helmets.

The MIG torch head shield 100 is preferably made of a high temperature plastic material, however other materials are hereby contemplated, including, but not limited to metal, etc. The MIG torch head shield 100 is preferably disposable, however the MIG torch head shield 100 may be reusable. The MIG torch head shield 100 is preferably flexible, thereby allowing for welding in tight areas without the MIG torch head shield 100 to not interfere. The MIG torch head shield 100 is a tinted shade.

The MG torch head shield 100 may have a removable, disposable inner lining 305 inside of the sidewall 304 to reveal a new clean surface for visibility, as the previous liner gets contaminated by arc spatter and outgassing of the welding process. The inner lining 305 will be of a high temperature plastic of a clear tint. Only the outer main embodiment will have the protective tinting needed to shield the user from the arc flash and radiation of the high intensity light.

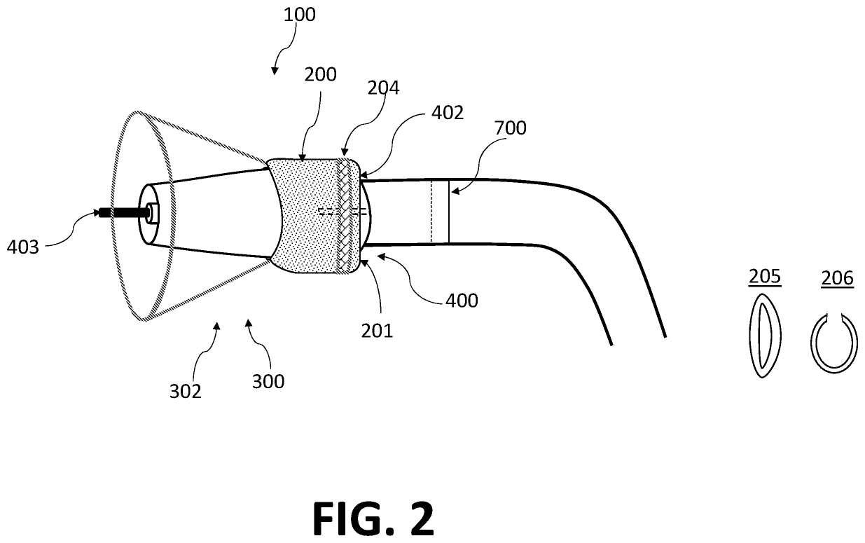

The MIG torch head shield 100 has a coupling portion 200 and a cone portion 300. The coupling portion 200 of the MIG torch head shield 100 has an inside 201, a first end 202 and a second end 203. The coupling portion 200 of the MIG torch head shield 100, will be further described in FIG. 2, is useful for friction coupling of the MIG torch head shield 100 to a MIG welder nozzle 700. The MIG torch head shield 100 is preferably made of a single material or film, however each of the coupling portion 200 and the cone portion 300 may be made separately.

The inside 201 of the coupling portion 200 of the MIG torch head shield 100 is necessarily hollow. The coupling portion 200 preferably has a diameter of thirteen-sixteenths ( 13/16) inch, however other diameters are hereby contemplated, including, but not limited to, one-half (½) inch, three-fourth (¾) inch, etc.

The cone portion 300 of the MIG torch head shield 100 has a first end 301, a second end 302, an inside 303 and a sidewall 304. The inside 303 of the cone portion 300 of the MIG torch head shield 100 is hollow. The cone portion 300 of the MIG torch head shield 100 is preferably flexible. The first end 301 of the cone portion 300 of the MIG torch head shield 100 is coupled to the second end 203 of the coupling portion 200 of the MIG torch head shield 100. The second end 302 of the cone portion 300 preferably has a diameter of one and one-half (1.5) inches, however other diameters are hereby contemplated, including, but not limited to, one and one-fourth (1.25) inches, two (2) inches, etc. The sidewall 304 of the cone portion 300 preferably has an angle of thirty degrees (30°), however other angles are hereby contemplated, including, but not limited to, forty-five degrees (45°).

Moving now to FIG. 2, an illustrated view of a MIG torch 400 with the MIG torch head shield 100 shown in FIG. 1 is presented.

The MIG torch 400 has a torch base 402 and a tip 403. The first end 201 of the coupling portion 200 of the MIG torch head shield 100 is placed over the tip 402 of the MIG torch 400 and is slid or maneuvered where the torch base 402 of the MIG torch 400 is on the inside 201 of the coupling portion 200 of the MIG torch head shield 100. The coupling portion 200 remains coupled to the torch base 402 of the MIG torch 400 by friction but not limited to friction (i.e. banding, clamping, springs, etc.). The tip 403 of the MIG torch 400 preferably extends one-fourth (¼) inch to one-half (½) inch (user-adjustable) from the second end 302 of the cone portion 300 of the MIG torch head shield 100, however other extended lengths are hereby contemplated, including, but not limited to, one-half (½), three-quarters (0.75) inch, one and one-half (1.5) inches, etc.

The coupling portion 200 further receives a nozzle 700. The coupling portion 200 of the MIG torch head shield 100 preferably has a retaining device 204, such as a spring retaining device, however other devices are hereby contemplated, including, but not limited to, rubber band 205, c-clip 206, etc.

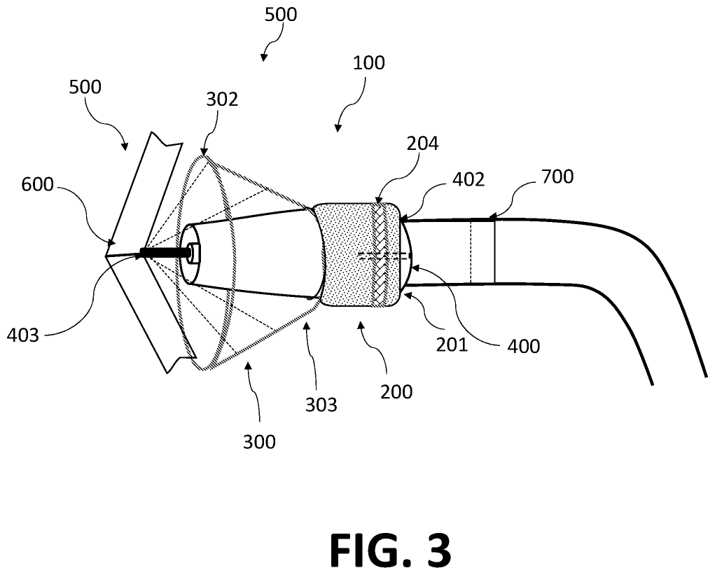

Referring now to FIG. 3, an illustrated view of an arc flash 500 of the MIG torch 400 shown in FIG. 2 with the MIG torch head shield 100 shown in FIG. 1 is presented.

The tip 403 of the MIG torch 400 is performing a weld on a piece of metal 600. The metal 600 oxidizes and expels an arc flash 500 from the heated metal 600. The arc flash 500 is shown where the arc flash 500 is reduced by making contact with the inside 303 of the cone portion 300 of the MIG torch head shield 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A MIG torch head shield for additional safety while performing MIG welding, the shield comprising:
a coupling portion, the coupling portion having an inside, a first end and a second end, wherein the coupling portion being coupled to a torch base of MIG torch; and
a shield, the shield having a first end, a second end, an inside and a sidewall, wherein the first end of the shield being coupled to the second end of the coupling portion.

2. The shield of claim 1, wherein the second end of the shield having a diameter being one and one-half (1.5) inches.

3. The shield of claim 1, wherein the sidewall of the shield having an angle being thirty degrees (30°).

4. The shield of claim 1, wherein the sidewall being a tinted shade.

5. The shield of claim 1, wherein the shield being made of a high temperature plastic material.

6. The shield of claim 1, wherein the shield being disposable.

7. The shield of claim 1, wherein the shield being flexible.

8. The shield of claim 1, wherein the shield being made of a single material.

9. The shield of claim 1, wherein the inside of the coupling device being hollow.

10. The shield of claim 1, wherein the inside of the shield being hollow.

11. The shield of claim 1, wherein the coupling portion having a diameter being thirteen-sixteenths ( 13/16) inch.

12. The shield of claim 1, wherein the coupling of the coupling portion to the torch body being by friction.

13. The shield of claim 1, wherein the coupling of the coupling portion to the torch body being by a retaining device.

14. The shield of claim 1, wherein the head shield has a removable, disposable inner lining.
